(19) United States
(12) Patent Application Publication
(10) Pub. No.: US 2013/0208984 A1
(43) Pub. Date: Aug. 15, 2013

(54) CONTENT SCENE DETERMINATION DEVICE

(71) Applicant: Ryota Mase, Tokyo (JP)

(72) Inventor: Ryota Mase, Tokyo (JP)

(73) Assignee: NEC CORPORATION, Tokyo (JP)

(21) Appl. No.: 13/822,670

(22) PCT Filed: Jun. 10, 2011
(86) PCT No.: PCT/JP2011/003291

§ 371 Date: Apr. 25, 2013

(30) Foreign Application Priority Data
Oct. 25, 2010 (JP) 2010-238095

(51) Int. Cl. G06K 9/00

(52) U.S. Cl. CPC G06K 9/00624
USPC 382/190

(57) ABSTRACT

The content related data extraction element extracts first content related data from input content. The first scene determination element compares the first content related data with first reference content related data, and determines a primary object included in the input content and an area, in the input content, where the primary object is present. The second scene determination element generates second content related data in which the influence of the area, which is determined that the primary object is present, is eliminated from the first content related data, compares the generated second content related data with second reference content related data, and determines a secondary object included in the input content.

### TECHNICAL FIELD

The present invention relates to a device which analyzes content such as an image and determines the scene of the content.

### BACKGROUND ART

In recent years, performance of cameras and audio devices, built in not only digital cameras and digital video cameras but also in mobile telephones, has been improved rapidly. As such, daily occurrences and encountered scenes can be recorded easily and accurately, so opportunities to acquire content in various situations are increasing. Along with it, technologies for automatically analyzing scene information representing the scene where the acquired content is captured, and utilizing the analysis result by associating it with the content, have been proposed.

For example, Patent Document 1 discloses a technology of determining a capturing scene using, together with image data of the captured image, camera information (capturing date/time information, capturing position information, etc.) acquired or input at the time of capturing and information related to the capturing scene (map information, weather information, event information, etc.) taken from a database or the like, and performing predetermined image processing corresponding to the estimated capturing scene, for the purpose of automatically generating high-quality images.

Further, Patent Document 2 discloses a technology of recognizing the face of a person and an area other than a person as different kinds of information, and for the purpose of improving the image quality of both kinds of information using different parameter values respectively, collecting capturing scenes of general people, determining a capturing scene in which a person area and a non-person area are combined through generation of a Mahalanobis space for the position, size, and form of the face in an average person capturing scene, and performing image processing appropriate for each area.
Patent Document 1: JP 2001-238177 A
Patent Document 2: JP 2000-278524 A

### SUMMARY

The technology disclosed in Patent Document 1 actively uses information uniquely extracted from one unit of content, such as date/time and place, to determine the scene. In this technology, only one piece of information is given to one unit of content. As such, it is impossible to give appropriate scene information accurately to each of a primary object (person area, etc.) and a secondary object (background, etc.) constituting the content.

On the other hand, the technology disclosed in Patent Document 2 provides a plurality of pieces of scene information to the content by using features (shade, edge, etc.) extracted from image data. However, in this technology, scene determination is performed simultaneously with respect to a primary object and a secondary object constituting the content. As such, among a plurality of pieces of reference data having been generated from a plurality of capturing scenes, a scene corresponding to reference data having the shortest Mahalanobis distance with the image data to be determined is used as a determination result. As such, in order to perform scene determination simultaneously on the primary object and the secondary object constituting the content, it is necessary to prepare a large amount of pieces of reference data in which primary objects (person, etc.) and secondary objects (background, etc.) in images are combined. Further, as the amount of pieces of reference data is large, the number of times of matching to be performed for scene determination becomes larger, so that a long processing time is required.

An object of the present invention is to provide a content scene determination device which solves the above-described problem, that is, a problem that in the case of performing scene determination simultaneously on a primary object and a secondary object constituting content, a large amount of pieces of reference data including both the primary object and the secondary object are required, so that a processing time becomes longer.

A content scene determination device, according to an aspect of the present invention, is adapted to include

an content related data extraction means for extracting first content related data from input content;

a first scene determination means for comparing the extracted first content related data with first reference content related data generated in advance from a plurality of pieces of first reference content including a primary object to be determined, and determining the primary object included in the input content and an area, in the input content, where the primary object is present; and

a second scene determination means for generating second content related data in which an influence of the area, which is determined that the primary object is present by the first scene determination means, is eliminated from the first content related data, comparing the generated second content related data with second reference content related data generated in advance from a plurality of pieces of second reference content including a secondary object to be determined, and determining the secondary object included in the input content.

With the above-described configuration, the present invention is able to reduce the number of pieces of reference data required for determining a scene with respect to both the primary object and the secondary object constituting content. Further, as the number of pieces of reference data is reduced, the number of times of matching to be performed for scene determination is reduced, whereby the time required for processing is reduced.

### BRIEF DESCRIPTION OF DRAWINGS

FIG. 1 is a block diagram showing the schematic configuration of a second exemplary embodiment.

FIG. 2 is a flowchart showing the whole of the second exemplary embodiment.

FIG. 3 is a block diagram showing an exemplary configuration of a second scene determination means.

FIG. 4 is a block diagram showing an exemplary configuration of a second scene determination means according to the second exemplary embodiment.

FIG. 5 is a block diagram showing an exemplary configuration of a content related data interpolation means according to the second exemplary embodiment.

FIG. 6 is a block diagram showing an exemplary configuration of the content related data interpolation means according to the second exemplary embodiment.

FIG. 7 is a block diagram showing an exemplary configuration of the content related data interpolation means according to the second exemplary embodiment.

FIG. 8 is a block diagram showing an exemplary configuration of the content related data interpolation means according to the second exemplary embodiment.

FIG. 9 is a block diagram showing an exemplary configuration of a second scene determination means according to a third exemplary embodiment.

FIG. 10 is a block diagram showing a first exemplary embodiment.

### EXEMPLARY EMBODIMENTS

Next, exemplary embodiments of the present invention will be described in detail with reference to the drawings.

### First Exemplary Embodiment

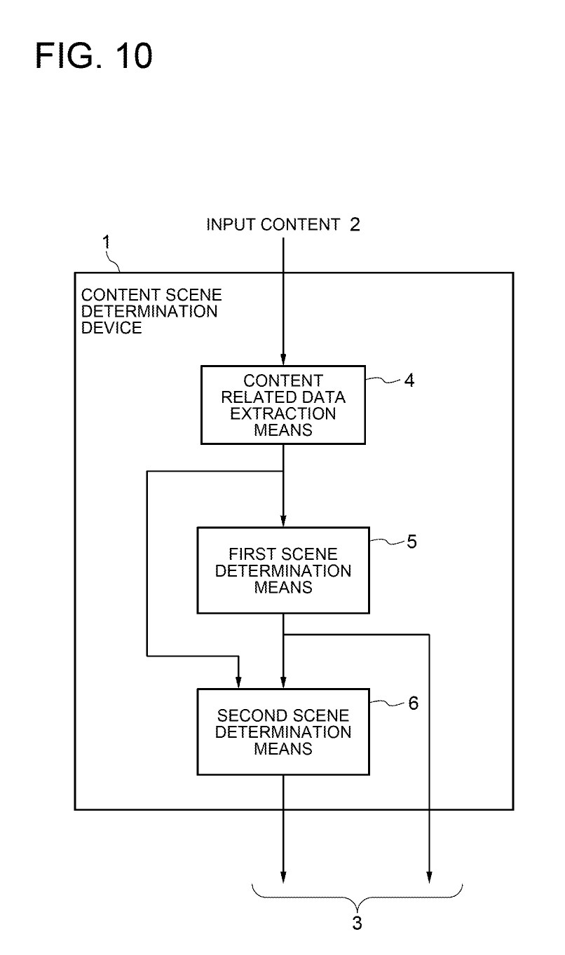

Referring to FIG. 10, a content scene determination device 1 according to a first exemplary embodiment of the present invention has a function of inputting and analyzing input content 2 and outputting a scene determination result 3. The content scene determination device 1 includes a content related data extraction means 4, a first scene determination means 5, and a second scene determination means 6.

The content related data extraction means 4 has a function of extracting first content related data from the input content 2.

The first scene determination means 5 has a function of comparing the first content related data extracted by the content related data extraction means 4 with one or more pieces of first reference content related data, and determining the primary object included in the input content 2 and an area where the primary object is present within the input content 2. The first reference content related data is generated in advance from a plurality of pieces of first reference content including the primary object to be determined, and is stored in a memory in the content scene determination device 1, for example.

The second scene determination means 6 has a function of generating, from the first content related data extracted by the content related data extraction means 4, second content related data by eliminating the influence of the area which is determined that the primary object is present by the first scene determination means 5. For example, the second scene determination means 6 may generate second content related data by replacing the data of the area which is determined that the primary object is present in the first content related data, with data generated by means of interpolation from data of an area other than the area which is determined that the primary object is present. Alternatively, the second scene determination means 6 may generate second content related data by removing the data of the area which is determined that the primary object is present in the first content related data.

The second scene determination means 6 also has a function of comparing the generated second content related data with one or a plurality of pieces of second reference content related data to determine a secondary object included in the input content 2. The second reference content related data is generated in advance from a plurality of pieces of second reference content including the secondary object to be determined, and stored in the memory of the content scene determination device 1, for example. Further, when generating second content related data by removing data of the area which is determined that the primary object is present in the first content related data, the second scene determination means 6 may compare a plurality of pieces of second reference content related data after removing the data corresponding to the area which is determined that the primary object is exist from the respective pieces of the second reference content related data, with the second content related data.

The scene determination result 3, output from the content scene determination device 1, includes a determination result of the first scene determination means 5 and a determination result of the second scene determination means 6.

The content scene determination device 1 can be configured of a processor such as a microprocessor, for example. Further, the content related data extraction means 4, the first scene determination means 5, and the second scene determination means 6 can be realized by a program stored in a memory connected with the processor. This program is read by the processor constituting the content scene determination device 1, and the program controls the operation of the processor, to thereby realize the content related data extraction means 4, the first scene determination means 5, and the second scene determination means 6 on the processor. The program may be stored in a computer-readable recording medium, that is, a portable medium such as a flexible disk, an optical disk, a magneto-optical disk, a semiconductor memory, for example, rather than the memory connected with the processor.

Next, operation of the content scene determination device 1 according to the present embodiment will be described.

First, the content related data extraction means 4 receives the input content 2, and extracts first content related data from the input content 2. Next, the first scene determination means 5 compares the first content related data, extracted by the content related data extraction means 4, with one or more pieces of first reference content related data, and determines the primary object included in the input content 2 and an area where the primary object is present in the input content 2. Next, the second scene determination means 6 generates, from the first content related data extracted by the content related data extraction means 4, second content related data by eliminating the influence of the area which is determined that the primary object is present by the first scene determination means 5. Further, the second scene determination means 6 compares the generated second content related data with one or more pieces of second reference content related data, and determines a secondary object included in the input content 2. Finally, the content scene determination device 1 outputs a scene determination result 3 including the determination result of the first scene determination means 5 and the determination result of the second scene determination means 6.

As described above, in the present embodiment, first, the first scene determination means 5 determines the primary object included in the input content 2 and the area, in the input content 2, where the primary object is present. As the first scene determination means 5 does not determine a secondary object included in the input content 2, it is not necessary that the first reference content, from which the first reference content related data is generated, includes the secondary object, basically. However, the first reference content may include the secondary object.

Further, in the present embodiment, the second scene determination means 6 generates second content related data by eliminating the influence of the area which is determined that the primary object is present from the first content related data extracted from the input content 2, compares the second content related data with one or more pieces of second reference content related data, and determines the secondary object included in the input content 2. As the second scene determination means 6 does not determine the primary object included in the input content 2, the second reference content, from which the second reference content related data is generated, does not include the primary object. Further, as the second scene determination means 6 generates the second content related data by eliminating the influence of the area which is determined that the primary object is present and compares it with the second reference content related data, the second scene determination means 6 is able to determine the secondary object without being affected by the primary object. As such, compared with the case where the influence of the area which is determined that the primary object is present is not eliminated, the accuracy of determining the secondary object is improved.

Further, as described above, the first reference content related data and the second reference content related data do not need to take into account a combination of the primary object and the secondary object. As such, the total number of pieces of reference content related data to be required is much smaller, compared with the total number of pieces of reference content related data to be required for determining the primary object and the secondary object at the same time. Consequently, the number of times of matching performed by the first scene determination means 5 and the second scene determination means 6 can be reduced significantly, whereby the processing time can be reduced.

### Second Exemplary Embodiment

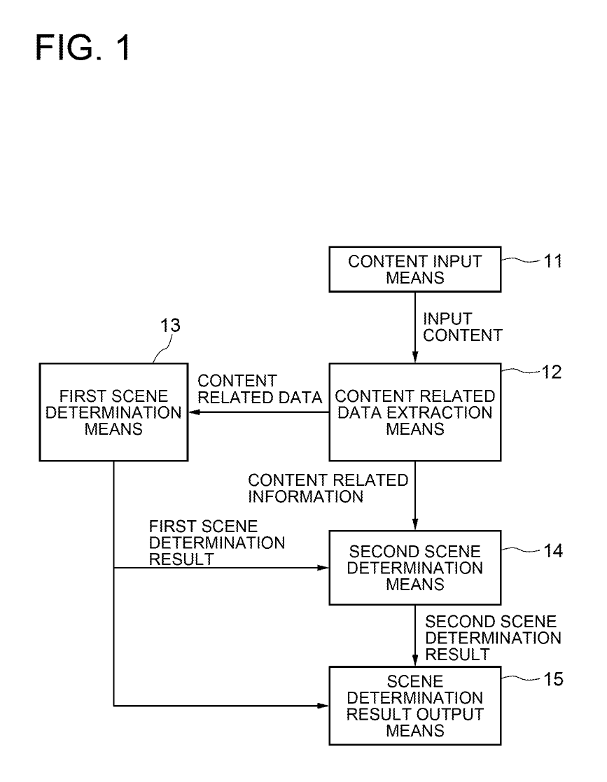

Referring to FIG. 1, a content scene determination device according to a second exemplary embodiment of the present invention includes a content input means 11 for inputting content which is subjected to scene determination, a content related data extraction means 12 for extracting various kinds of data related to the input content, a first scene determination means 13 for determining, by using the extracted content related data, a primary object included in the input content and an area, in the input content, where the primary object is present, a second scene determination means 14 for eliminating the influence of the area of the primary object from the input content and determining a secondary object included in the input content, and a scene determination result output means 15 for outputting a first scene determination result and a second scene determination result.

Here, content represents photographs, moving images (including short clips), audio, sounds, and the like. Further, various kinds of data related to content represents, if the content is a photograph, data of the pixel value, data of features extracted by applying some processing to the pixel value, and the like. Further, a primary object represents one which can be a main subject such as a person, a pet, a car, or the like, for example. Further, a secondary object represents one other than the primary object in the content such as a background area, for example.

The content input means 11 inputs images captured through a digital camera, a digital video camera, an image pickup device of a mobile telephone, a scanner, or the like, as input content. The input content may be a compressed image such as JPEG, or a non-compressed image such as TIFF, PSD, or RAW. Further, the input content may be a compressed moving image or a decoded moving image, and in that case, it is input by each frame image. In the case of a compressed moving image, the compression format may be any decodable format such as MPEG, MOTION JPEG, WINDOWS Media Video, or the like. Further, the content input means 11 is realized by a CPU with a program which runs according to predetermined rules, for example.

The content related data extraction means 12 receives the input content from the content input means 11, and extracts various kinds of data related to the input content as content related data. For example, if the input content is an image, the content related data extraction means 12 extracts data of the pixel value, data of the image features calculated by applying some processing to the pixel value, and the like. If the input content is uncompressed image, the content related data extraction means 12 extracts a data portion in which the pixel value is recorded, while if the input content is compressed image, the content related data extraction means 12 extracts a data portion in which the pixel value is recorded after decoding it. Further, when extracting the features, the content related data extraction means 12 extracts features such as color arrangements in the image, a color histogram, a histogram of edge patterns in each direction of each partial area, visual features of MPEG 7, or the like, through application of an edge detection filter such as a two-dimensional Laplacian filter or a Canny filter, acquisition of color information, or the like. If the input content is acoustic data, the content related data extraction means 12 extracts features such as MFCC, acoustic power, acoustic features of MPEG 7, or the like. The content related data extraction means 12 is realized by a CPU with a program which runs according to the predetermined rules.

The first scene determination means 13 receives content relate data from the content related data extraction means 12, and outputs a detection result in the input content of an object which can be a main subject of the content such as a person, a pet, a car, or the like, and the existing position information thereof, as a first scene determination result. The first scene determination means 13 is realized by, for example, a CPU with a program which runs according to the predetermine rules. The details of the first scene determination means 13 will be described below.

The second scene determination means 14 receives the content related data from the content related data extraction means 12, and receives the first scene determination result from the first scene determination means 13, and after eliminating the influence of the primary object from the input content, outputs a result of determining what kind of secondary object is included in the input content, as a second scene determination result. The second scene determination means 14 is realized by, for example, a CPU with a program which runs according to the predetermined rules. The details of the second scene determination means 14 will be described below.

The scene determination result output means 15 outputs scene information to be provided to the input content, determined by the first scene determination means 13 and the second scene determination means 14, respectively. For example, if the scene determination result output means 15 is implemented as a program and information is notified to the program for executing processing of the subsequent stage via a memory, the scene determination result output means 15 outputs the scene information, to be provided to the input content, to the memory.

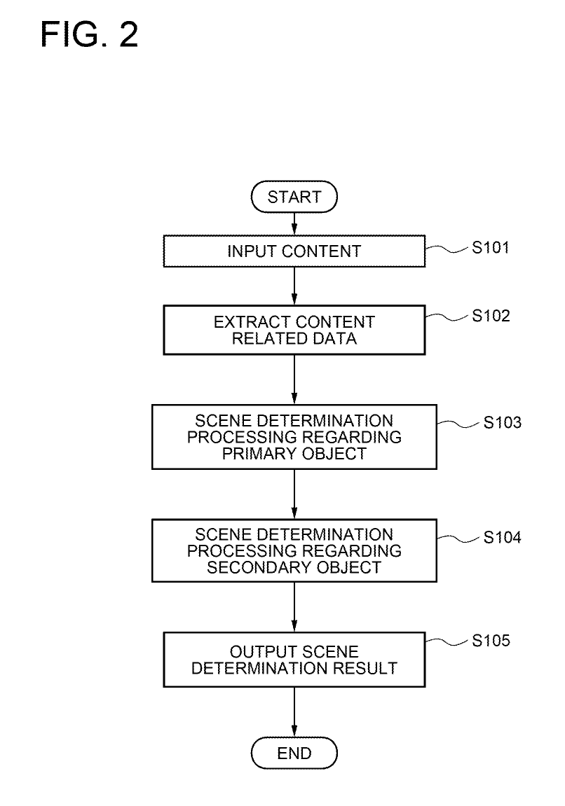

FIG. 2 is a flowchart for explaining the overall processing flow of the second exemplary embodiment shown in FIG. 1. As shown in FIG. 2, first, the content input means 11 inputs content such as a photograph (S101). Then, the content related data extraction means 12 extracts data of pixel values and data of features as content related data, from the input content (S102). Then, the first scene determination means 13 performs determination regarding a primary object included in the input content and its existing position (S103). Then, the second scene determination means 14 uses the determination result of the first scene determination means 13 to perform scene determination regarding a secondary object included in the input content (S104). Then, the scene determination result output means 15 outputs a first scene determination result and a second scene determination result (S105).

With the above-described configuration, the first scene determination means 13 first determines the scene of the primary object included in the input content, and then, the second scene determination means 14 determines the scene of the secondary object included in the input content after eliminating the influence of the primary object. As such, it is possible to provide scene information appropriate to the primary object and the secondary object respectively, and further, to reduce the total number of times of matching required for determining the scenes with respect to the primary object and the secondary object, whereby scene determination can be performed in a short processing time. As a result, it is possible to perform scene determination with respect to a plurality of areas constituting the content such as a person area, a pet area, a background area, and the like, in a short processing time.

Further, as scene determination with respect to a plurality of areas of the input content is performed for each of the areas, rather than using the result of scene determination performed on the entire areas of the content, it is possible to perform scene determination with respect to a plurality of areas constituting the content with high accuracy even if a large amount of reference data, including combinations of a plurality of areas, is not available.

Next, the first scene determination means 13 will be described in detail.

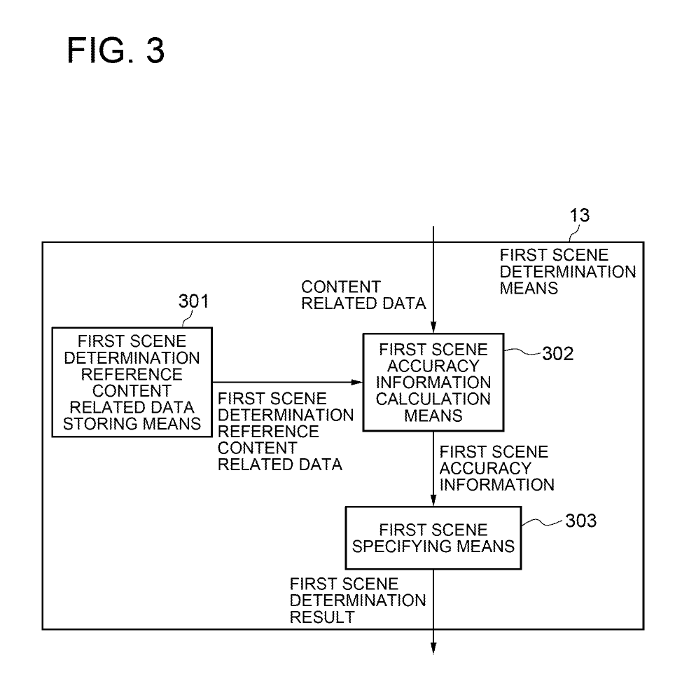

Referring to FIG. 3, an example of the first scene determination means 13 includes a first scene determination reference content related data storing means 301, a first scene accuracy information calculation means 302, and a first scene specifying means 303.

The first scene determination reference content related data storing means 301 uses pixel value information of the position, where each object is present, extracted from a plurality of pieces of reference content including an object which can be a main subject of the content such as a person, a pet, a car, or the like, to store information describing a model when modeling the distribution of the pixel values of each object as reference content related data. In that case, the first scene determination reference content related data storing means 301 stores, for example, function information and parameter value of the most fitted case when distribution of pixel values of each object is modeled using a simple function, support vector of SVM, parameters of projection axis obtained by linear determination, and the like.

Further, the first scene determination reference content related data storing means 301 may store information describing a model used when modeling distribution of the features of each object extracted from a plurality of pieces of reference content including an object which can be a main subject of the content such as a person, a pet, a car, or the like, as reference content related data. In this way, if features extracted from content are used as reference content related data, at least one of the features to be used must be a feature including position information in the content, like a histogram of edge patterns in each direction of each partial area.

The first scene accuracy information calculation means 302 receives content related data from the content related data extraction means 12 and receives reference content related data from the first scene determination reference content related data storing means 301, and outputs first scene accuracy information using those pieces of data. For example, if data of pixel values of the input content is input as content related data and information relating to the center of gravity of each scene (object) class is input as reference content related data, the first scene accuracy information calculation means 302 considers the distance up to the center of gravity of each scene class for the pixel vale of each pixel input from the content related data extraction means 12, and outputs the ratio of each scene corresponding to the value as first scene accuracy information. Further, the first scene accuracy information calculation means 302 may output, as first scene accuracy information, an index indicating the degree that each pixel is determined as each scene, based on the result of the case of using linear determination analysis, the result of the case of using SVM, or the like. In the case of receiving data of features as content related data from the content related data extraction means 12, at least one of the features to be received must be a feature including position information in the content, like a histogram of edge patterns in each direction of each partial area, and the first scene accuracy information calculation means 302 performs matching with the reference content related data regarding the feature including the position information. By performing such matching, even if data of features is used as content related data, it is possible to compare distribution of the features of each object with the features in a partial area of the input content, so that an index indicating the degree that each partial area in the content is determined as each scene is calculated.

The first scene specifying means 303 receives first scene accuracy information from the first scene accuracy information calculation means 302, and outputs a first scene determination result. For example, if an index indicating a degree that each pixel is determined by each scene is input as first scene accuracy information, regarding each pixel, it is considered that the first scene specifying means 303 extracts a scene having the highest value in the index and assigns a unique identifier representing the scene. Specifically, the first scene specifying means 303 outputs, as a first scene determination result, data in which a value, corresponding to the determination result of whether or not an object which can be a main subject is shown in the input content, is stored for each pixel, such that a pixel determined that a person is shown is 0, a pixel determined that a pet is shown is 1, a pixel determined that another main subject such as a car is shown is 2, and a pixel determined that there is no main subject is 3. It is also possible that the first scene determination result is information regarding a scene which is present in the input content and the coordinate position where the scene is present, rather than the determination result regarding the entire pixels.

Next, a second scene determination means 14 will be described in detail.

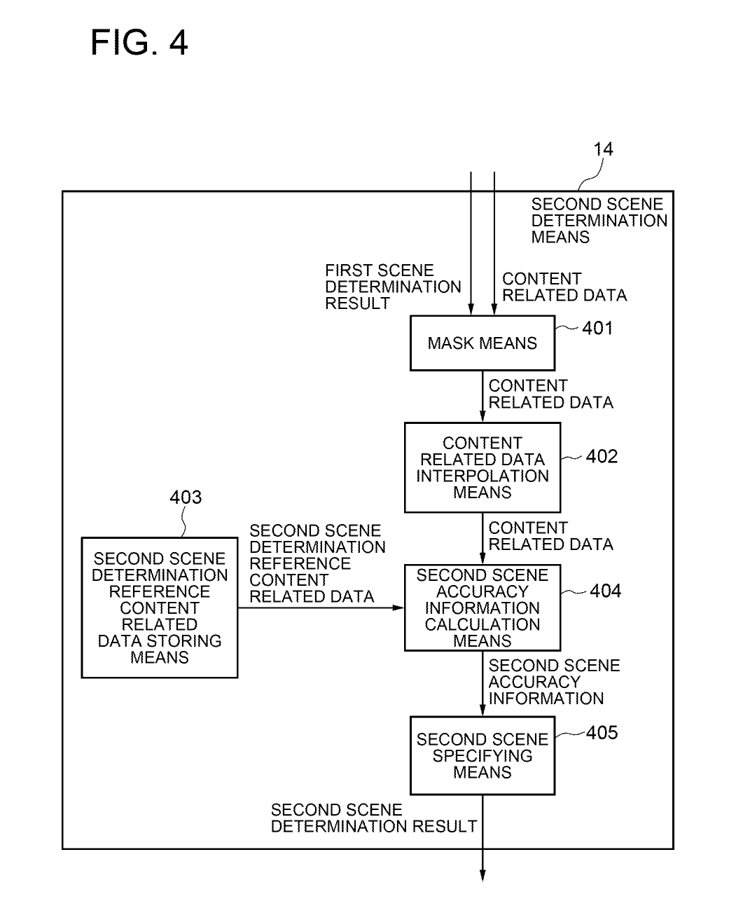

Referring to FIG. 4, an example of the second scene determination means 14 includes a mask means 401, a content related data interpolation means 402, a second scene determination reference content related data storing means 403, a second scene accuracy information calculation means 404, and a second scene specifying means 405.

The mask means 401 receives the content related data from the content related data extraction means 12 and receives the first scene determination result from the first scene determination means 13, and regarding the content related data, after performing mask processing on the area where the primary object is present, outputs the content related data on after the mask processing. For example, if the first scene determination result received from the first scene determination means 13 is information in which a unique identifier representing a scene is assigned for each pixel, the mask means 401 handles a pixel, which has been determined that a main subject is present, such that data of the pixel values or data of the features is unknown. If the first scene determination result received from the first scene determination means 13 is a determination result that an object which can be a main subject is not present in the content, the mask means 401 does not perform mask processing. In this way, by eliminating the influence of the content related data extracted from the area where the primary object is present, it is possible to perform accurate scene determination processing regarding the secondary object.

The content related data interpolation means 402 receives the content related data after the mask processing from the mask means 401, and uses the content related data in the area other than the masked area to perform interpolation processing of the content related data on the masked area, that is, the area where the primary object is present, and then, outputs the content related data after the interpolation. The detailed description of the content related data interpolation means 402 will be given below.

The function of the second scene determination reference content related data storing means 403 is similar to that of the first scene determination reference content related data storing means 301 shown in FIG. 3. However, it is different in that the reference content related data to be stored is not generated from a plurality of pieces of content including an object which can be a main subject of the content such as a person, a pet, a car, or the like, but generated from a plurality of pieces of content not including those objects.

The second scene determination reference content related data storing means 403 stores information describing a model when modeling the distribution of pixel values of each scene from a plurality of pieces of content showing scenes which can be backgrounds when the content is captured such as “landscapes” including mountains and seas, “night views”, “sunset” and the like, as reference content related data. In that case, the second scene determination reference content related data storing means 403 stores, for example, function information when the distribution of pixel values of each scene is modeled by a simple function, parameter values of the most fitted case, a support vector of SVM, a parameter of a projection axis obtained by linear determination, and the like.

Further, the second scene determination reference content related data storing means 403 uses features extracted from a plurality of pieces of content showing scenes which can be backgrounds, to store information describing a model when modeling the distribution of features of each scene as reference content related data.

The function of the second scene accuracy information calculation means 404 is similar to that of the first scene accuracy information calculation means 302 in FIG. 3, but is different in that when receiving data of features as content related model data, it is not necessary that the features include position information in the content. This means that the second scene accuracy information calculation means 404 does not need to calculate an index indicating the degree of being determined as each scene with respect to a partial area of the content, but only needs to calculate it with respect to the entire content.

The function of the second scene specifying means 405 is similar to that of the first scene specifying means 303 shown in FIG. 3, but is different in that it is not necessary to output information regarding the position in the content displaying the matter representing the scene. For example, if an index indicating the degree to be determined as each scene is input as second scene accuracy information, the second scene specifying means 405 may output a scene having the highest value thereof or several scenes having higher values as a scene determination result.

Next, some exemplary configurations of the content related data interpolation means 402 will be described.

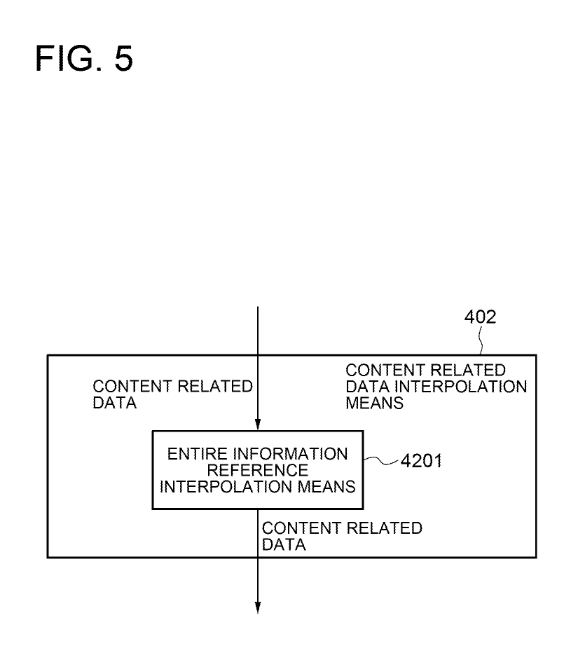

Referring to FIG. 5, an example of the content related data interpolation means 402 is configured of an entire information reference interpolation means 4201.

The entire information reference interpolation means 4201 receives content related data after mask processing from the mask means 401, and after interpolating the content related data of the masked area by referring to the entire area other than the masked area, outputs the interpolated content related data. As a method of interpolating the masked area by referring to the entire area other than the masked area, uniform interpolation using the average value of the entire referred area may be considered, for example.

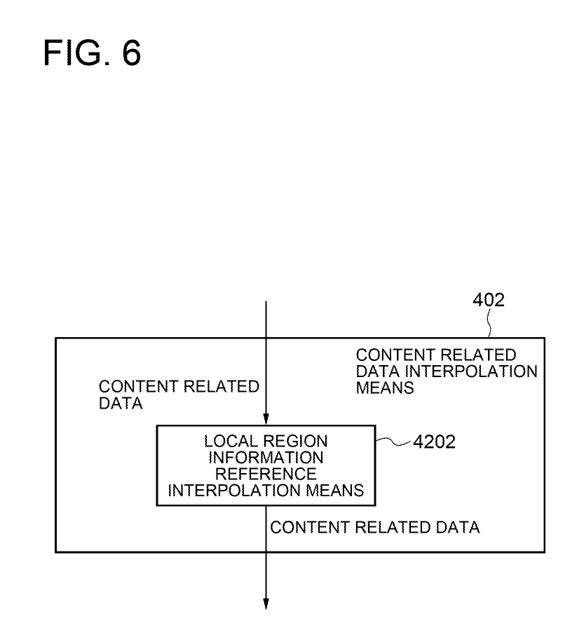

Referring to FIG. 6, another example of the content related data interpolation means 402 is configured of a local area information reference interpolation means 4202.

The local area information reference interpolation means 4202 receives content related data after mask processing from the mask means 401, and after interpolating the content related data of the masked area by referring to the local area around the masked area, outputs the interpolated content related data. As an interpolation method with reference to the local area around the masked area, a method in which a rectangle of a given size, vertically and horizontally, is shifted gradually around the masked area and interpolation is performed on the masked area within the rectangle using the average value of the area other than the masked area within the rectangle, may be considered, for example. The area considered as a local area may be a circular area or an elliptic area, rather than a rectangular area.

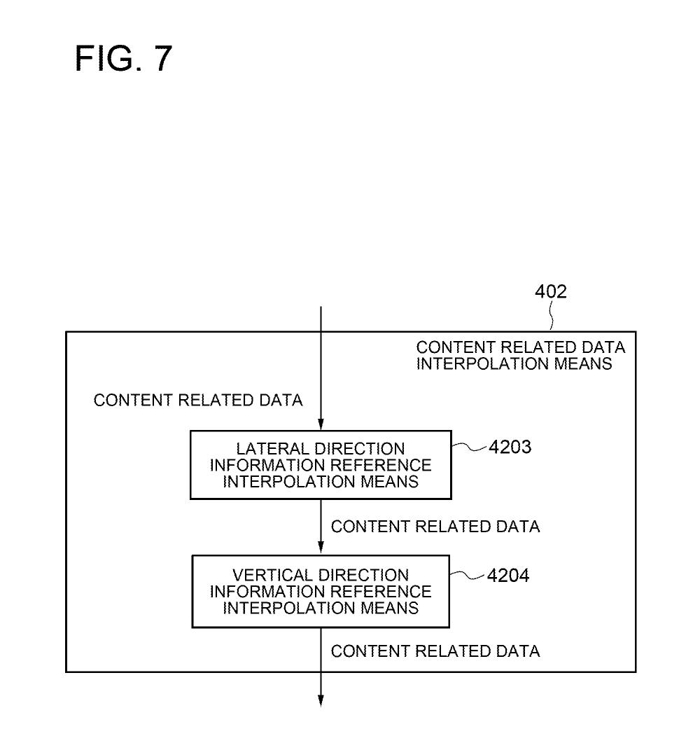

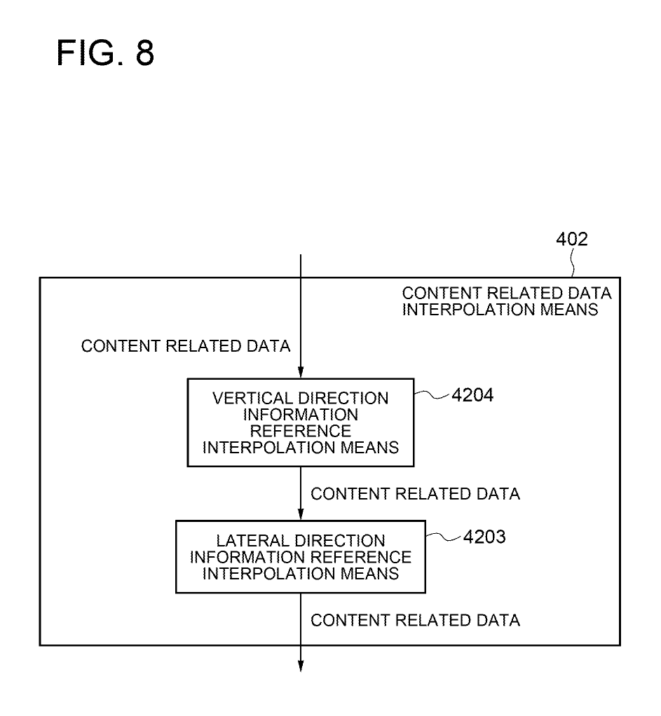

Referring to FIGS. 7 and 8, another example of the content related data interpolation means 402 is configured of a lateral direction information reference interpolation means 4203 and a vertical direction information reference interpolation means 4204. FIG. 7 shows a configuration of first performing interpolation while referring to information of a lateral direction and then performing interpolation while referring to information of a vertical direction. In contrast, FIG. 8 shows a configuration of first performing interpolation while referring to information of a vertical direction and then performing interpolation while referring to information of a lateral direction.

As an interpolation method by referring to information in a lateral direction by the lateral direction information reference interpolation means 4203, a method of focusing on data in a row direction in the content related data and performing interpolation on the masked area on the same row using the average value of the entire data in the area other than the masked area on the same row, may be considered, for example. Interpolation to be performed on the masked area on the same row may be performed by linearly interpolating the data adjacent to the masked area on the row. Alternatively, interpolation to be performed on the masked area on the same row may be performed by layering filters each of which is provided with its center at the data of an area other than the masked area on the row.

Interpolation to be performed by referring to the information in a vertical direction by the vertical direction information reference interpolation means 4204 is similar to the case of a horizontal direction, except that the data to be focused on is not on the same row but on the same column. As such, the details thereof are not described herein.

As described above, in the scene determination of the present embodiment, determination of a scene (object) which can be a main subject such as a person, a pet, a car, or the like and determination of a background scene are not performed together in one determination, but determination of whether or not a scene which can be a main subject is present in the content, and its existing position, is performed first. Then, after interpolating the information of the content, in which a scene which can be a main subject is not present at the existing position, using information of the content in other areas, the scene of the content in the background area is determined. Thereby, even when most of the area serving an important role for determining the scene of the content of the background area is hidden due to the influence of the presence of the scene which can be a main subject, if such a area remains even the slightest, the area to be useful in scene determination of the content of the background area can be restored. As such, it is possible to perform scene determination of the background area with high accuracy. Further, in this scene determination method, it is not necessary to consider that existing positions of the scene, which can be a main subject, are various with respect to the respective background scenes, so that the total number of image sets which must be registered in the database can be reduced. As a result, the total number of times of matching required for scene determination with respect to both areas can be reduced significantly, so that it is possible to perform scene determination with respect to the content in a short processing time.

### Third Exemplary Embodiment

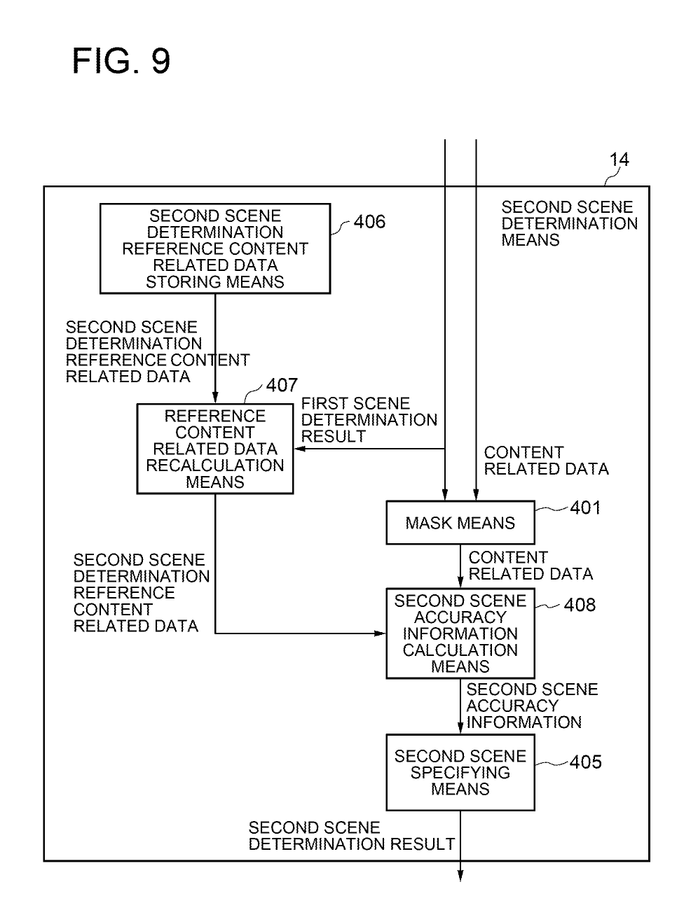

Next, a third exemplary embodiment of the present invention will be described with reference to the drawings. The third exemplary embodiment is different from the second exemplary embodiment in that the second scene determination means 14 is configured as shown in FIG. 9. Other constituent elements are the same as those of the second exemplary embodiment, so the detailed description thereof is not repeated herein.

Referring to FIG. 9, the second scene determination means 14 used in the third exemplary embodiment includes the mask means 401, the second scene determination means 405, a second scene determination reference content related data storing 406, a reference content related data recalculation means 407, and a second scene accuracy information calculation means 408.

The functions of the mask means 401 and the second scene determination means 405 are the same as those in the second exemplary embodiment shown in FIG. 4. As such, the detailed description thereof is not repeated herein.

The function of the second scene determination reference content related data storing means 406 is almost similar to that of the second scene determination reference content related data storing means 403 in the second exemplary embodiment shown in FIG. 4, except that the format of data to be stored is limited. Specifically, in the second scene determination reference content related data storing means 406, content related data extracted from a plurality of pieces of content to be used for modeling respective scenes is kept as it is, or the content related data is kept in a restorable format with accuracy of a certain level or higher. The content related data may be data of pixel values or data of features. In the case of data of features, features including the position information in the content are also required, like a histogram of edge patterns in each direction of each partial area.

The reference content related data recalculation means 407 receives a first scene determination result from the first scene determination means 13, and receives second scene determination reference content related data from the second scene determination reference content related data storing means 406, and recalculates the second scene determination reference content related data. Specifically, with respect to the reference content related data received from the second scene determination reference content related data storing means 406, the reference content related data recalculation means 407 uses the first scene determination result, received from the first scene determination means 13, to eliminate content related data at a position corresponding to the area where the primary object is present.

If the content related data is data of pixel values, then the reference content related data recalculation means 407 eliminates data of pixel values corresponding to the area where the primary object is present with respect to each of a plurality of pieces of content to be used for modeling each scene, and then recalculates information describing the model when modeling the distribution of the pixel values of each scene as reference content related data. Similarly, if the content related data is data of features, after eliminating data of features at a position corresponding to the area where the primary object is present with respect to features each extracted from each of a plurality of pieces of content to be used for modeling each scene, the reference content related data recalculation means 407 recalculates information describing the model when modeling the distribution of the features of each scene as reference content related data. With this processing, it is possible to determine the scene of the secondary object with high accuracy without being affected by the primary object.

The function of the second scene accuracy information calculation means 408 is almost similar to that of the second scene accuracy information calculation means 404 of the second exemplary embodiment shown in FIG. 4, except that content related data received from the mask means 401 is data which is not interpolated with respect to the area where the primary object is present. Further, reference content related data received from the second scene determination reference content related data recalculation means 407 is also model data calculated without using content related data at a position corresponding to area where the primary object is present. The second scene accuracy information calculation means 408 performs matching between the model data and the content related data received from the mask means 401, and outputs second scene accuracy information.

In the scene determination of the present embodiment, determination of a scene (object) which can be a main subject such as a person, a pet, a car, or the like and determination of a background scene are not performed together in one time determination, but determination of whether or not a scene which can be a main subject is present in the content, and its existing position, is performed first. Then, without using the information of the content at the existing position, the scene of the content shown in the background area is determined only using the content in the other areas. Thereby, as the quantity of information of the content to be used for determining the scene of the background area is reduced, scene determination of the background area can be performed at a high speed even considering the amount of processing to be increased due to recalculation of the model data. Further, similar to the second exemplary embodiment, in this scene determination method, it is not necessary to consider that existing positions of the scene which can be a main subject are various with respect to respective background scenes, so that the total number of image sets required to be registered in the database can be reduced. As a result, the total number of times of matching required for scene determination with respect to both areas can be reduced significantly, whereby the total time for scene determination with respect to the content can be reduced.

The present invention is based upon and claims the benefit of priority from Japanese patent application No. 2010-238095, filed on Oct. 25, 2010, the disclosure of which is incorporated herein in its entirety by reference.

### INDUSTRIAL APPLICABILITY

According to the present invention, as it is possible to provide a plurality of pieces of scene information to content such as photographs, moving images, and sounds captured by various devices, the present invention is applicable to a system which improves the quality of content with appropriate setting for each partial area in the content.

The whole or part of the exemplary embodiments disclosed above can be described as, but not limited to, the following supplementary notes.

### (Supplementary Note 1)

A content scene determination device comprising:

content related data extraction means for extracting first content related data from input content;

first scene determination means for comparing the extracted first content related data with first reference content related data generated in advance from a plurality of pieces of first reference content including a primary object to be determined, and determining the primary object included in the input content and an area, in the input content, where the primary object is present; and

second scene determination means for generating second content related data in which an influence of the area, which is determined that the primary object is present by the first scene determination means, is eliminated from the first content related data, comparing the generated second content related data with second reference content related data generated in advance from a plurality of pieces of second reference content including a secondary object to be determined, and determining the secondary object included in the input content.

### (Supplementary Note 2)

The content scene determination device, according to supplementary note 1, wherein

the second scene determination means generates the second content related data by replacing data of the area which is determined that the primary object is present in the first content related data, with data generated by interpolation from data of an area other than the area which is determined that the primary object is present.

### (Supplementary Note 3)

The content scene determination device, according to supplementary note 1, wherein

the second scene determination means generates the second content related data by removing data of the area which is determined that the primary object is present in the first content related data.

### (Supplementary Note 4)

The content scene determination device, according to supplementary note 3, wherein

the second scene determination means compares the plurality of the pieces of the second reference content related data after removing the data corresponding to the area, which is determined that the primary object is present, from each of the plurality of the pieces of the second reference content related data, with the second content related data.

### (Supplementary Note 5)

The content scene determination device, according to any of supplementary notes 1 to 4, wherein

the input content is an image, the primary object is a predetermined main subject, and the secondary object is a background.

### (Supplementary Note 6)

A content scene determination method comprising:

extracting first content related data from input content:

comparing the extracted first content related data with first reference content related data generated in advance from a plurality of pieces of first reference content including a primary object to be determined, and determining the primary object included in the input content and an area, in the input content, where the primary object is present; and

generating second content related data in which an influence of the area, which is determined that the primary object is present, is eliminated from the first content related data, comparing the generated second content related data with second reference content related data generated in advance from a plurality of pieces of second reference content including a secondary object to be determined, and determining the secondary object included in the input content.

### (Supplementary Note 7)

The content scene determination method, according to supplementary note 6, wherein

the determining the secondary object included in the input content includes generating the second content related data by replacing data of the area which is determined that the primary object is present in the first content related data, with data generated by interpolation from data of an area other than the area which is determined that the primary object is present.

### (Supplementary Note 8)

The content scene determination method, according to supplementary note 6, wherein

the determining the secondary object included in the input content includes generating the second content related data by removing data of the area which is determined that the primary object is present in the first content related data.

### (Supplementary Note 9)

The content scene determination method, according to supplementary note 8, wherein

the determining the secondary object included in the input content includes comparing the plurality of the pieces of the second reference content related data after removing the data corresponding to the area, which is determined that the primary object is present, from each of the plurality of the pieces of the second reference content related data, with the second content related data.

### (Supplementary Note 10)

The content scene determination method, according to any of supplementary notes 6 to 9, wherein

the input content is an image, the primary object is a predetermined main subject, and the secondary object is a background.

### (Supplementary Note 11)

A program for causing a computer to function as:

content related data extraction means for extracting first content related data from input content;

first scene determination means for comparing the extracted first content related data with first reference content related data generated in advance from a plurality of pieces of first reference content including a primary object to be determined, and determining the primary object included in the input content and an area, in the input content, where the primary object is present; and

second scene determination means for generating second content related data in which an influence of the area, which is determined that the primary object is present by the first scene determination means, is eliminated from the first content related data, comparing the generated second content related data with second reference content related data generated in advance from a plurality of pieces of second reference content including a secondary object to be determined, and determining the secondary object included in the input content.

### (Supplementary Note 12)

A content scene determination device comprising

a memory that stores input content, first reference content related data generated in advance from a plurality of pieces of first reference content including a primary object to be determined, and second reference content related data generated in advance from a plurality of pieces of second reference content including a secondary object to be determined; and

a processor connected with the memory, wherein

the processor is programmed to

extract first content related data from the input content;

compare the extracted first content related data with the first reference content related data, and determine a primary object included in the input content and an area, in the input content, where the primary object is present; and

generate second content related data in which an influence of the area, which is determined that the primary object is present, is eliminated from the first content related data, and

compare the generated second content related data with the second reference content related data, and determine a secondary object included in the input content.

### REFERENCE NUMERALS

1 content scene determination device
2 input content
3 scene determination result
4 content related data extraction means
5 first scene determination means
6 second scene determination means
11 content input means
12 content related data extraction means
13 first scene determination means
14 second scene determination means
15 scene determination result output means
301 first scene determination reference content related data storing means
302 first scene accuracy information calculation means
303 first scene specifying means
401 mask means
402 content related data interpolation means
403 second scene determination reference content related data storing means
404 second scene accuracy information calculation means
405 second scene specifying means
406 second scene determination reference content related data storing means
407 second scene determination reference content related data recalculation means
408 second scene accuracy information calculation means
4201 entire information reference interpolation means
4202 local area information reference interpolation means
4203 lateral direction information reference interpolation means
4204 vertical direction information reference interpolation means

1. A content scene determination device comprising:
a content related data extraction unit that extracts predefined data as first content related data from input content;
a first scene determination unit that compares the extracted first content related data with a plurality of pieces of first reference content related data, and determines a primary object included in the input content and an area, in the input content, where the primary object is present; and
a second scene determination unit that generates, as second content related data, data in which an influence of the area, which is determined that the primary object is present by the first scene determination unit, is eliminated from the first content related data, compares the generated second content related data with a plurality of pieces of second reference content related data, and determines a secondary object included in the input content.

2. The content scene determination device, according to claim 1, wherein
in generating the second content related data, the second scene determination unit generates the second content related data by replacing data of the area which is determined that the primary object is present in the first content related data, with data generated by interpolation from data of an area other than the area which is determined that the primary object is present.

3. The content scene determination device, according to claim 1, wherein
in generating the second content related data, the second scene determination unit generates the second content related data by removing data of the area which is determined that the primary object is present in the first content related data.

4. The content scene determination device, according to claim 3, wherein
in comparing the second content related data with the second reference content related data, the second scene determination unit compares the plurality of the pieces of the second reference content related data after removing the data corresponding to the area, which is determined that the primary object is present, from each of the plurality of the pieces of the second reference content related data, with the second content related data.

5. The content scene determination device, according to claim 1, wherein
the input content is an image, the primary object is a predetermined main subject, and the secondary object is a background.

6. A content scene determination method comprising:
extracting predefined data as first content related data from input content;
comparing the extracted first content related data with a plurality of pieces of first reference content related data, and determining a primary object included in the input content and an area, in the input content, where the primary object is present; and
generating, as second content related data, data in which an influence of the area, which is determined that the primary object is present, is eliminated from the first content related data, comparing the generated second content related data with a plurality of pieces of second reference content related data, and determining a secondary object included in the input content.

7. The content scene determination method, according to claim 6, wherein
the generating the second content related data includes generating the second content related data by replacing data of the area which is determined that the primary object is present in the first content related data, with data generated by interpolation from data of an area other than the area which is determined that the primary object is present.

8. The content scene determination method, according to claim 6, wherein
the generating the second content related data includes generating the second content related data by removing data of the area which is determined that the primary object is present in the first content related data.

9. The content scene determination method, according to claim 8, wherein
the comparing the second content related data with the second reference content related data includes comparing the plurality of the pieces of the second reference content related data after removing the data corresponding to the area, which is determined that the primary object is present, from each of the plurality of the pieces of the second reference content related data, with the second content related data.

10. A non-transitory computer readable medium storing a computer program comprising instructions for causing a computer to function as:
a content related data extraction unit that extracts predefined data as first content related data from input content;
a first scene determination unit that compares the extracted first content related data with a plurality of pieces of first reference content related data, and determines a primary object included in the input content and an area, in the input content, where the primary object is present; and
a second scene determination unit that generates, as second content related data, data in which an influence of the area, which is determined that the primary object is present by the first scene determination unit, is eliminated from the first content related data, compares the generated second content related data with a plurality of pieces of second reference content related data, and determines a secondary object included in the input content.

11. The content scene determination device, according to claim 2, wherein
the input content is an image, the primary object is a predetermined main subject, and the secondary object is a background.

12. The content scene determination device, according to claim 3, wherein
the input content is an image, the primary object is a predetermined main subject, and the secondary object is a background.

13. The content scene determination device, according to claim 4, wherein
the input content is an image, the primary object is a predetermined main subject, and the secondary object is a background.
